(19) United States
(12) Patent Application Publication
(10) Pub. No.: US 2006/0260740 A1
(43) Pub. Date: Nov. 23, 2006

(54) Home and Office, Cold Seal, Manual, Thermal Trimmed Continuous Adhesive Web Laminating Device

(75) Inventors: Anthony J. Lammers, Gates Mills, OH (US); John R. Nottingham, Bratenahl, OH (US); John W. Spirk, Gates Mills, OH (US); Patrick W. Brown, Auburn, OH (US)

Correspondence Address: KEEVICAN WEISS BAUERLE & HIRSCH LLC;(FORMERLY KNOWN AS DKW LAW GROUP LLC), 11TH FLOOR, FEDERATED INVESTORS TOWER, 1001 LIBERTY AVENUE, PITTSBURGH, PA, 15222, US

(73) Assignee: INNODESK, INC, Beachwood, OH (US)

(21) Appl. No.: 11/419,180

(22) Filed: May 18, 2006

Related U.S. Application Data
(60) Provisional application No. 60/682,156, filed on May 18, 2005.

(51) Int. Cl. B32B 38/04; B32B 37/00

(52) U.S. Cl. 156/250; 156/522; 156/523; 156/580

(57) ABSTRACT

A frame assembly supports a pair of rolls of clear plastic laminating tape. The two rolls of laminating tape are rotatably disposed facing the other, top and bottom, and dispense toward the center towards a stationary bar to the fore of the device. The frame is open to the rear and a rear feed guide is used to insert a web of cardstock or paper so that the inserted material is directed in between the convergent tape rolls so as to be adhesively secured on top and bottom to the laminating tape. The cardstock is advanced through the tape rolls by pulling the forward distal ends of the laminating rolls. A cutting bar that moves downward to meet the stationary bar. The web of stock and laminating tape form a laminated sheet that is cut off by applying downward pressure against the cutting bar on the stationary bar. A resistive heating element may be provided to cut the laminating tape thermally.

### RELATED APPLICATIONS

This application claims the benefit of U.S. Provisional patent application Ser. No. 60/682,156 entitled “Adhesive Roll Laminating Device” filed May 18, 2005.

### BACKGROUND OF THE INVENTION

1. Field of the Invention

The present invention relates generally to devices for laminating substrates with laminating film. More particularly, the present invention relates to a home or office use, cold seal, manual, pull though, thermal trimmed continuous adhesive web laminating device.

2. Background Information

Laminating devices are commonly used for encapsulating media such as cardstock, paper or the like between thin laminating coating, namely clear or transparent plastic film sheets. The plastic encapsulation provides a more durable article that is less disposed to damage from water, is smear-proof, and which maintains its original shape and appearance for a much longer period of time. Items such as driver's licenses, photo ID cards, business cards, display articles and photographs, are a few examples of items that may be protected using laminating techniques.

Originally, laminating devices employed thermal setting adhesives in order to activate the encapsulation coating. These methods normally required an electrical power source for the laminating coating and were designed for larger commercial office operations. Later, cold lamination methods were developed, using adhesives. These cold laminating devices are also typically designed for large scale operations, and not economical for an individual or small business operation. Within the meaning of this application, such non-thermal setting laminating coatings will be referred to as cold sealing or cold seal coatings or laminations.

U.S. Pat. Nos. 5,580,417, 5,735,998, 5788,806 and 5,961,779 all disclose a complex multi-purpose laminating and adhesive transfer apparatus which has a frame or housing with mounting means for receiving a cartridge which is insertable to supply material to perform the necessary laminating or adhesive transfer operation. The cartridge has a box-like housing in which upper and lower supply rolls containing webs of laminating or adhesive transfer material are rotatively secured. The rolls have tensioning caps which can be adjusted to prevent the supply rolls from overrunning as they pay-out material. The caps are pre-set in accordance with the operation being performed and the characteristics of the material. The tensioning caps may be pre-set by the material supplier at the time they are inserted into the cartridge. The user selects the cartridge appropriate to the operation to be performed for either adhesive transfer (e.g. label making) or laminating.

U.S. Pat. No. 6,431244 describes a complex laminating apparatus having a pair of upper and lower pinch rollers that are disposed at the paper feed-out side of the sheet cassette. Both pinch rollers are structured so as to rotate in synchronization with a turn of an external handle. Paper put on a paper supply tray is fed to the gap between the upper and lower sheet rollers, and the paper is sandwiched there between and laminated while drawing the upper and lower sheets. A laminate thus formed is cut in a direction perpendicular to a feed direction of the paper) using a lateral cutter blade. Accordingly, the paper laminated by sheets of a PET film (laminate) can be obtained. However, in the previous laminating apparatus of this type, the paper, which is a laminate target, is manually inserted into a sheet laminating unit for laminating an upper and lower sheet in the sheet cassette after putting the paper on the paper feed tray. Therefore, this patent suggests that there is a problem that it is burdensome to manually perform the inserting operation. In response, this patent proposed a motor-driven laminating apparatus. The paper feed rollers, the pinch rollers, and a pair of paper feed-out rollers are synchronized with each other and driven via an electric motor and a power transmission mechanism, thereby automatically supplying paper on the paper supply tray to the sheet laminating unit.

These prior art devices, however, include are costly and inefficient to operate and maintain, and thus unacceptable for convenient home and office use.

### SUMMARY OF THE INVENTION

The various embodiments and examples of the present invention as presented herein are understood to be illustrative of the present invention and not restrictive thereof and are non-limiting with respect to the scope of the invention.

According to one embodiment of the present invention addressing at least some of the above stated objects a laminating device includes a housing having an open end configured to receive a substrate to be laminated there in, a pair of rolls of adhesive backed laminating film rotatably coupled to the housing and adapted to have the laminating film feed there from, and a thermal trimming unit provided with an electrical resistance-heating element designed to melt and sever the laminating film to trim the final laminated substrate.

In one non-limiting embodiment of the present invention the invention includes that the thermal trimming unit is moveably mounted on the housing. The thermal trimming unit may include a switch that is configured to be closed as the thermal trimming unit is moved to a trimming position. The electrical resistance heating element of the thermal trimming unit may be a wire that is battery powered. The housing may include a base with a groove therein, wherein the wire of the thermal trimming unit is configured to at least be partially received within the groove when in the trimming position. The rolls may be configured to manually advance the laminating film through a manual pulling of the laminating film from a forward end of the housing.

In one non-limiting embodiment of the present invention the invention includes that the rolls are formed as part of a replaceable cartridge. The compact, cold seal, thermal trimmed laminating device according to one non-limiting embodiment may further comprise a pair of curved guides disposed between the tape rolls which are formed integral with the replaceable cartridge.

In one non-limiting embodiment of the present invention the invention includes that the housing has brackets configured to receive the rolls in a replaceable position, and that the housing is of a molded construction.

The compact, cold seal, thermal trimmed laminating device according to one non-limiting embodiment may further comprise a side trimming unit that can trim the width of the laminating film. The side trimming unit may be adjustable to selectively trim the laminating film to a desired lamination width.

The compact, cold seal, thermal trimmed laminating device according to one non-limiting embodiment may further comprise pressure roller or rollers disposed transversely between side walls of the housing and configured to engage against the laminating film and the substrate.

The present invention further provides, in one non-limiting aspect of the invention, a method of laminating a substrate. The method comprising the step of providing a compact, cold seal, thermal trimmed laminating device including a housing having an open end configured to receive a substrate to be laminated there in, a pair of rolls of adhesive backed laminating film rotatably coupled to the housing and adapted to have the laminating film feed there from, and a thermal trimming unit provided with an electrical resistance-heating element designed to melt and sever the laminating film to trim the final laminated substrate. The method further includes the steps of manually inserting the substrate to be laminated in the open end of the housing engaging the opposed film from the rolls, whereby the adhesive backed film will engage both surfaces of the substrate securing the substrate to the laminating films; manually grasping the leading ends of the film from the rolls at another end of the housing; pulling the film to rotate the rolls and manually advance the film and the associated substrate until the substrate is entirely passed the trimming location of the trimming unit; and actuating the thermal trimming unit to engage the laminating film and sever the laminating film to form the laminated substrate.

These and other advantages of the present invention will be clarified in the description of the preferred embodiments taken together with the attached figures.

### BRIEF DESCRIPTION OF THE DRAWINGS

FIG. 1 is a perspective view of a home or office based, cold seal, manual, pull though, thermal trimmed continuous adhesive web laminating device in accordance with one embodiment of the present invention;

FIG. 2 is a perspective view of the laminating device according to FIG. 1 with the device trimming the laminated article;

FIG. 3 is an exploded perspective view of a home or office based, cold seal, manual, pull though, thermal trimmed continuous adhesive web laminating device in accordance with another embodiment of the present invention;

FIG. 4 is an exploded perspective view of an a home or office based, cold seal, manual, pull though, thermal trimmed continuous adhesive web laminating device in accordance with another embodiment of the present invention;

FIG. 5 is a schematic electrical diagram of the thermal trimming unit for the laminating device in accordance with the present invention;

FIG. 6 is a schematic front elevation view of the thermal trimming unit for the laminating device together with an optional side trimming unit in accordance with the present invention; and

FIG. 7 is a schematic side elevation view of the thermal trimming unit and side trimming unit of FIG. 6.

### DESCRIPTION OF THE PREFERRED EMBODIMENTS

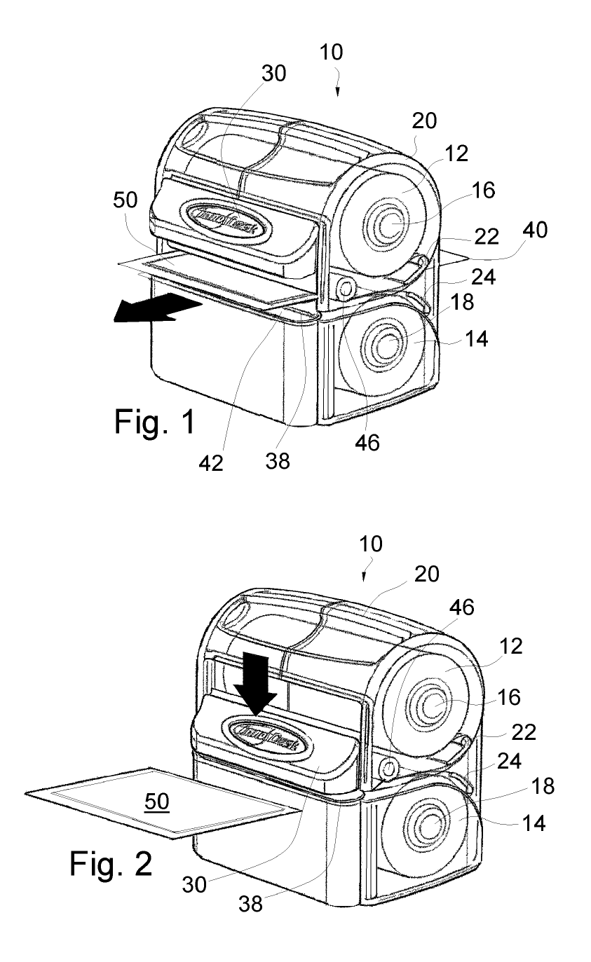

FIGS. 1-2 illustrate a laminating device 10 in accordance with the present invention. As described below the device 10 is a home or office based, cold seal, manual, pull though, thermal trimmed continuous adhesive web laminating device 10. The reference to home or office use references that the device 10 is a compact unit that is easy to use. The simple construction of the device 10 also makes it applicable for home or office use. As discussed above the cold seal references that the device uses non-thermosetting adhesive backed film or laminating film or tape. The cold seal aspect also makes the device 10 applicable for home or small office use. The manual reference indicates that the device 10 does not feed the laminating film nor the substrate with electrically powered motors, rather it is manual action that provides for the substrate and laminating film or tape advancement. The reference to pull through indicates that the manual laminating film advancement is by pulling of the film. Finally the phrase that the device 10 is a thermally trimmed continuous adhesive web is indicative of using a roll of laminating film or adhesive web that is trimmed with a thermal trimming unit. The continuous term references that the roll of laminating film, the web, is significantly longer than most substrates 40 to be laminated. These aspects of the present invention will be further clarified in the following description.

The device 10 includes a pair of generally clear plastic adhesive backed tape rolls 12, 14 that form the laminating film. The rolls 12 and 14 may have different grades of film and adhesive coating thereon as known in the art. For example a transparent tinted film could be used for a color lamination. A relatively thick film could be used for a relatively heavy duty lamination. The adhesive must have a low enough shear strength to allow the laminating film to be peeled from the roll, which is of general skill in the art. It is preferable that the rolls 12 and 14 do not use a release layer construction which would increase the scrap generated with machine use. The rolls 12 and 14 may be referenced as tape rolls, adhesive rolls, laminating film rolls, adhesive webs, or other terms generally known in the art to reference the roll of adhesive backed laminating film. The rolls 12 and 14 obviously form a finite length of laminating film, however such rolls 12 and 14 are far longer than typical substrates 40 to be laminated, such that, relative to the substrate 40, the rolls 12 and 14 are “continuous adhesive webs”. The continuous references that the same web or roll 12 and 14 is used for multiple substrates 40, whereas certain prior art lamination systems have discrete lamination sheets (i.e. non-continuous) that conform to a single substrate 40. As described below the device 10 is designed as a “pull through” system to advance the substrate and the film from the rolls 12 and 14. Hand crank gear coupled drive rollers could also be used for manual advancement (as known from prior art systems), but the pull through system of the present invention, as shown, is considered to be less complex, easier for replacement of the rolls 12 and 14, and more economical. Consequently the pull through current system is preferred.

The rolls 12 and 14 are mountable on spools 16 and 18, respectively, which traverse the laminating device 10, through the tape rolls 12 and 14, between sidewalls of the housing 20. The spools 16 and 18 may have any conventional construction that allows for easy rotational mounting of the rolls 12 and 14 on the housing 20. The housing 20, or frame assembly, of the laminating device 10 will generally be a molded plastic unit for ease of manufacture and to easily provide an atheistically pleasing overall configuration.

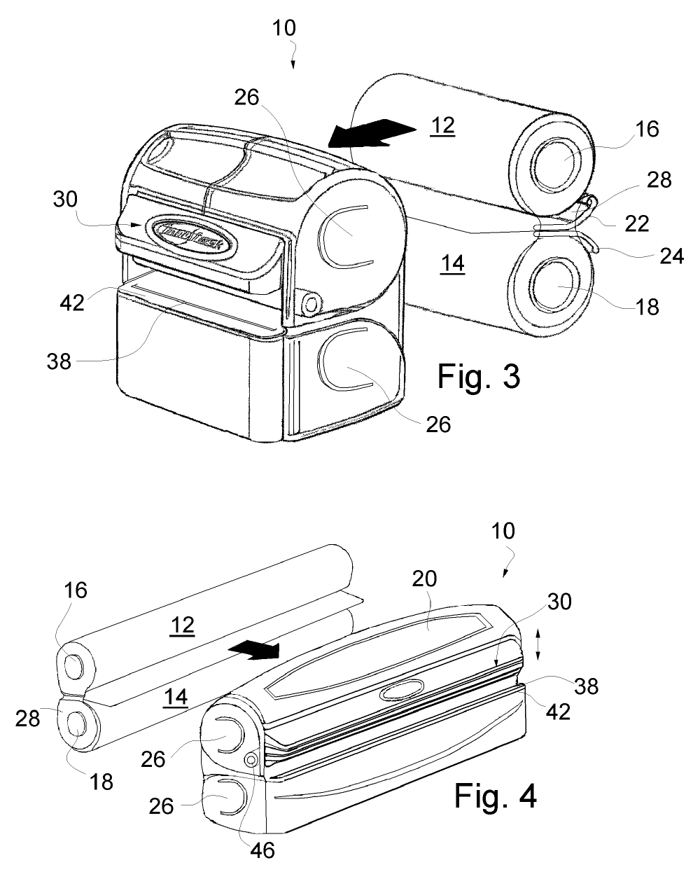

As shown in the embodiments of FIGS. 3 and 4, the rolls 12 and 14 may be connected through a sub-frame 28 to form a replaceable unit, as shown. The replaceable unit, or cartridge, allows the device 10 to be re-filled when the rolls 12 and 14 run out of laminating film. The housing 20 may include brackets 26 for receiving the rolls 12 and 14 easily and securely. A pair of curved guides 22 and 24 may be disposed between the tape rolls 12, 14, and part of the integral unit or cartridge as shown in FIGS. 3 and 4. The guides 22 and 24 serve to guide the substrate 40 to be laminated, such as a piece of card stock or paper, into the center point where the two tape rolls 12 and 14 meet. As the substrate 40 is inserted, the adhesive side of the tape from rolls 12 and 14 contacts the substrate 40 and adheres thereto as it moves through the laminating device 10.

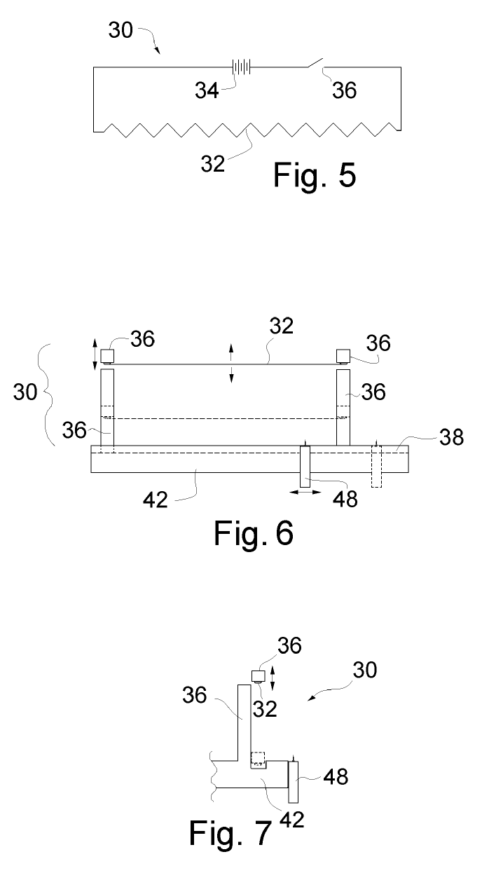

The device 10 includes a thermal trimming unit 30, also called a cutting bar, moveably mounted on the housing 20. The unit 30 may be spring biased to the non-trimming position shown in FIG. 1. The thermal trimming unit 30 is provided with an electrical resistance-heating element 32 designed to melt the laminating film to trim the final laminated substrate 50. FIG. 5 is a schematic electrical diagram of the thermal trimming unit 30 for the laminating device 10, and it includes an electrical resistance heating element 32 heated by a battery supply 34 when an electrical switch 36 is closed. The battery supply 34 may be in the housing 20 in any convenient location. It is anticipated that the battery supply 34 may be replaced with an electrical plug for receiving power from a conventional electrical outlet. The heating element 32 is generally in the form of a straight wire that will heat the laminating film sufficiently to easily, quickly trim the finished laminated substrate 50. The wire forming the element 32 must be formed such that it heats quickly and is rugged enough for repeated operation. The trimming unit 30 preferably includes a protective molded plastic unit housing as shown in FIGS. 1-4 for aesthetic appeal and to minimize contact with the thermal cutting wire.

As shown in FIGS. 6 and 7 the switch 36 may be formed of contacts that engage to close the switch 36 as the unit 30 is slid down toward the trimming position shown in FIG. 2. The housing 20 includes a base 42, or stationary bar, which the trimming unit 30 engages against. The base 42 may have a groove 38 for receiving the wire of the trimming unit 30 as shown schematically in FIGS. 6-7.

Further, the device 10 may have a side trimming unit 48 that can trim the width of the laminating film to a desired lamination width. This alternative may be preferable to a series of different width machines or devices 10 such as shown in FIGS. 3 and 4. The cutting mechanism for the side trimming unit may be a blade, a rotary trimming wheel or pair of wheels, a thermal cutting wire, thermal assisted cutting blade, thermal assisted trimming wheel or wheels, or other cutting device as desired. Alternatively the trimming of the width of the final laminated substrate 50 may be left to the user to accomplish with a separate device such a scissors.

One or more guide or pressure rollers 46 may be provided disposed transversely between side walls of the housing 20. The guide roller 46 (or rollers) will provide a pressure roller to engage against the laminating film and the substrate 40 to form a tight connection between the opposed laminating film to form a final laminated substrate 50 with minimal imperfections (e.g. air bubbles). The roller(s) 46 may be mounted directly between the side walls of the housing 20 with a resilient construction (i.e. rubber or the like) sufficient to maintain pressure on the substrate 40 and associated film while accommodating substrates of some variable thickness. A spring biased mounting of the roller(s) 46 may also be used to maintain pressure on the laminating film and substrate 40.

In operation the user will merely manually insert the substrate to be laminated in the open rear side of the housing 20 between the guides 22 and 24 and engaging the opposed film from the rolls 12 and 14. The adhesive backed film will engage both surfaces of the substrate 40 securing the substrate 40 to the laminating films. The user can then grasp the leading ends of the film from the rolls 12 and 14 at the forward end of the housing 20, which will typically be on the base 42 immediately adjacent the groove 38 (due to the previous trimming operation). The user will pull the film, which will rotate the rolls 12 and 14 and advance the film and the associated substrate 40. If the substrate 40 is a relatively long member then the user can pull the film at the forward end of the device 40 with one hand while supporting and pushing the substrate 40 with the other, however in most application the initial coupling between the film and the substrate 40 at the initial insertion of the substrate 40 will be sufficient coupling to have the film pull the substrate through without further assistance. The substrate 40 and laminating film from rolls 12 and 14 will be advanced through the device until the substrate 40 is entirely passed the trimming location of the trimming unit 30 (i.e. beyond the groove 38). At this point the trimming unit 30 is slid downward, closing the switch 36, activating the heating element 32 of the cutting wire to heat and sever the laminating film to form the laminated substrate 50. The leading ends of the laminating film from rolls 12 and 14 will be adjacent the groove 38, ready for the next lamination of a subsequent substrate 40.

The laminated substrate 50 may have the width of the laminating films trimmed with separate tools as desired, or, in an alternative embodiment, the side trimming unit 48 can be slid into a desired trimming position on the base 42 prior to the lamination procedure to provide for a width adjustment.

Whereas particular embodiments of this invention have been described above for purposes of illustration and in the attached summary sheet, it will be evident to those skilled in the art that numerous variations of the details of the present invention may be made without departing from the invention.

We claim:

1. A laminating device comprising:
a frame assembly having a stationary bar disposed to the fore of the frame assembly and open to the rear;
a rear feed guide for inserting a web of cardstock or paper;
two pairs of rolls of laminating tape being rotatably disposed facing the other, top and bottom, and dispensing toward the center; so that the inserted material is directed in between the convergent tape rolls so as to be adhesively secured on top and bottom to the laminating tape from both pairs of rolls and combining to form a laminated sheet;
means for supporting a pair of rolls of laminating tape; and
a cutting bar adjacent to said stationary bar with means for cutting through the laminating tape to sever the laminated sheet.

2. The laminating device according to claim 1, wherein the cutting means is a resistive beating wire powered by one or more batteries to melt and sever the laminating tape.

3. A compact, cold seal, thermal trimmed laminating device comprising:
A housing having an open end configured to receive a substrate to be laminated there in;
A pair of rolls of adhesive backed laminating film rotatably coupled to the housing and adapted to have the laminating film feed there from; and
A thermal trimming unit provided with an electrical resistance-heating element designed to melt and sever the laminating film to trim the final laminated substrate.

4. The compact, cold seal, thermal trimmed laminating device according to claim 3 wherein the thermal trimming unit is moveably mounted on the housing.

5. The compact, cold seal, thermal trimmed laminating device according to claim 4 wherein the thermal trimming unit includes a switch that is configured to be closed as the thermal trimming unit is moved to a trimming position.

6. The compact, cold seal, thermal trimmed laminating device according to claim 5 wherein the electrical resistance heating element of the thermal trimming unit is a wire that is battery powered.

7. The compact, cold seal, thermal trimmed laminating device according to claim 6 wherein the housing includes a base with a groove therein, wherein the wire of the thermal trimming unit is configured to at least be partially received within the groove when in the trimming position.

8. The compact, cold seal, thermal trimmed laminating device according to claim 7 wherein the rolls are configured to manually advance the laminating film through a manual pulling of the laminating film from a forward end of the housing.

9. The compact, cold seal, thermal trimmed laminating device according to claim 3 further comprising a pair of curved guides disposed between the tape rolls.

10. The compact, cold seal, thermal trimmed laminating device according to claim 3 wherein the rolls are formed as part of a replaceable cartridge.

11. The compact, cold seal, thermal trimmed laminating device according to claim 10 further comprising a pair of curved guides disposed between the tape rolls which are formed integral with the replaceable cartridge.

12. The compact, cold seal, thermal trimmed laminating device according to claim 3 wherein the housing includes brackets configured to receive the rolls in a replaceable position.

13. The compact, cold seal, thermal trimmed laminating device according to claim 12 wherein the housing is of a molded construction.

14. The compact, cold seal, thermal trimmed laminating device according to claim 3 further including a side trimming unit that can trim the width of the laminating film.

15. The compact, cold seal, thermal trimmed laminating device according to claim 14 wherein the side trimming unit is adjustable to selectively trim the laminating film to a desired lamination width.

16. The compact, cold seal, thermal trimmed laminating device according to claim 3 further including at least one pressure roller disposed transversely between side walls of the housing and configured to engage against the laminating film and the substrate.

17. A method of laminating a substrate comprising the steps of:
A) providing a compact, cold seal, thermal trimmed laminating device including a housing having an open end configured to receive a substrate to be laminated there in, a pair of rolls of adhesive backed laminating film rotatably coupled to the housing and adapted to have the laminating film feed there from, and a thermal trimming unit provided with an electrical resistance-heating element designed to melt and sever the laminating film to trim the final laminated substrate;
B) Manually inserting the substrate to be laminated in the open end of the housing engaging the opposed film from the rolls, whereby the adhesive backed film will engage both surfaces of the substrate securing the substrate to the laminating films;
C) Manually grasping the leading ends of the film from the rolls at another end of the housing;
D) Pulling the film to rotate the rolls and manually advance the film and the associated substrate until the substrate is entirely passed the trimming location of the trimming unit; and
E) Actuating the thermal trimming unit to engage the laminating film and sever the laminating film to form the laminated substrate.

18. The method of laminating a substrate according to claim 17 wherein the thermal trimming unit is moveably mounted on the housing, and the step of activating the thermal trimming unit includes moving the trimming unit to a trimming position.

19. The method of laminating a substrate according to claim 18 wherein the thermal trimming unit includes a switch that is configured to be closed as the thermal trimming unit is moved to the trimming position.

20. The method of laminating a substrate according to claim 19 wherein the electrical resistance heating element of the thermal trimming unit is a wire that is battery powered.
